(19) United States
(12) Patent Application Publication
(10) Pub. No.: US 2025/0213343 A1
(43) Pub. Date: Jul. 3, 2025

(54) MOBILE DENTAL DELIVERY SYSTEM

(71) Applicant: Midmark Corporation, Versailles, OH (US)

(72) Inventors: Matthew A. Tangeman, New Bremen, OH (US); Preston T. Rathge, North Ridgeville, OH (US)

(21) Appl. No.: 18/985,332

(22) Filed: Dec. 18, 2024

Related U.S. Application Data
(60) Provisional application No. 63/615,941, filed on Dec. 29, 2023.

(51) Int. Cl. A61D 5/00

(52) U.S. Cl. CPC A61D 5/00

(57) ABSTRACT

The disclosure relates to a mobile dental delivery system designed for enhanced serviceability and maintenance. The system features a housing defining an upper service chamber, a middle service chamber, and a lower service chamber, each having an access panel, door, or the like configured to selectively reveal the associated chamber for servicing the components therein as desired. The system further includes a compressor service assembly removably disposed within the lower service chamber and connected via tubing/wires to components within the housing. The tubing/wiring between the compressor service assembly and the other components of the mobile dental delivery system are of a sufficient length to allow the complete removal of the compressor service assembly from the housing, while maintaining the tubing connection to the other components, to facilitate 360-degree access to the elements of the compressor service assembly such as a compressor or a pressure switch.

### BACKGROUND

Veterinary dentistry has increasingly embraced mobile dental delivery systems, commonly known as “mobile dental units” or “dental carts.” While these units have improved dental care in various settings due to their mobility, they are not without their challenges, particularly regarding servicing internal components and providing routine maintenance.

A notable issue with current mobile dental units is the complexity involved in accessing and servicing their internal components. These units are often intricately designed, with components tightly packed within the housing. This compact arrangement, while beneficial for mobility, makes routine maintenance tasks such as replacing tubing, fine tuning elements, emptying drains, or repairing internal mechanisms a cumbersome and time-consuming process. For veterinarians or technicians, this complexity can lead to prolonged downtime of the unit, which is not ideal in a busy veterinary practice.

Furthermore, the intricate design of these units often requires specialized knowledge or tools for effective maintenance, which may not be readily available in all veterinary settings. A common task such as emptying a drain could require tools or specialized knowledge in some designs. This necessity can lead to increased reliance on external service providers, adding to the operational costs, increased time, and complicating the logistics of maintaining the unit, especially in remote or underserved areas.

Another concern is the wear and tear of frequently used components. In a mobile unit, parts such as hoses, connectors, and moving panels are subject to regular stress, leading to quicker degradation. However, the design of these units doesn't always allow for easy replacement or repair of these high-wear components. As a result, what could be a simple replacement task can turn into a significant undertaking, requiring partial or complete disassembly of the unit.

These maintenance and servicing challenges highlight the need for a new generation of mobile dental units. Ideally, these units would be designed with ease of serviceability and maintenance in mind, featuring components that can be quickly accessed, serviced, or replaced. Such improvements would not only enhance the functionality and longevity of the units but also ensure that veterinarians can provide uninterrupted, high-quality dental care in a variety of settings.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a perspective view of a front area of an exemplary mobile dental delivery system comprising an upper section, middle section, and lower section;

FIG. 2 depicts another perspective view of a back area of the mobile dental delivery system of FIG. 1;

FIG. 3 depicts a perspective view of an upper section of the mobile dental delivery system of FIG. 1, oriented to present a control panel in the upper section;

FIG. 4 depicts a perspective view of a top panel of the upper section of FIG. 3, with a removable tray partially removed;

FIG. 5. depicts a perspective view of the top panel of FIG. 3 in an open position, the open position exposing an upper service chamber;

FIG. 6 depicts a view of the back area of the mobile dental delivery system of FIG. 1 with housing removed to illustrate internal components of the upper section, middle section, and lower section;

FIG. 7 depicts a perspective view of one or more storage bins in the middle section of the mobile delivery system of FIG. 1, after a storage door has been opened to reveal the one or more storage bins;

FIG. 8 depicts a perspective view of a service chamber in the middle section of the mobile delivery system of FIG. 1 with an access door in the closed position;

FIG. 9 depicts a perspective view of the service chamber in the middle section of the mobile delivery system of FIG. 1 with the access door in the open position;

FIG. 10 depicts an enlarged perspective view of a water bottle of the mobile delivery system of FIG. 1, the water bottle comprising a lock collar which is shown engaged with a connector of the mobile delivery system;

FIG. 11 depicts a perspective view of the water bottle of FIG. 10 disengaged with the connector; and

FIG. 12 depicts a perspective view of a compressor in a compressor service assembly in the lower section of the mobile delivery system of FIG. 1, the compressor service assembly shown completely removed from a lower service chamber of the lower section.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. Mobile Dental Delivery System

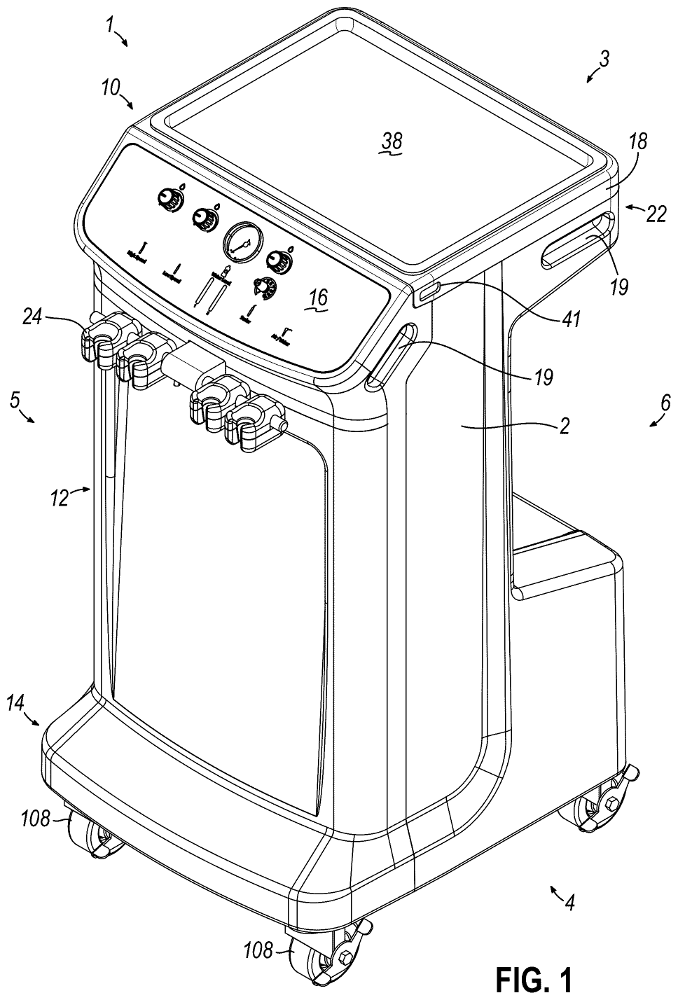

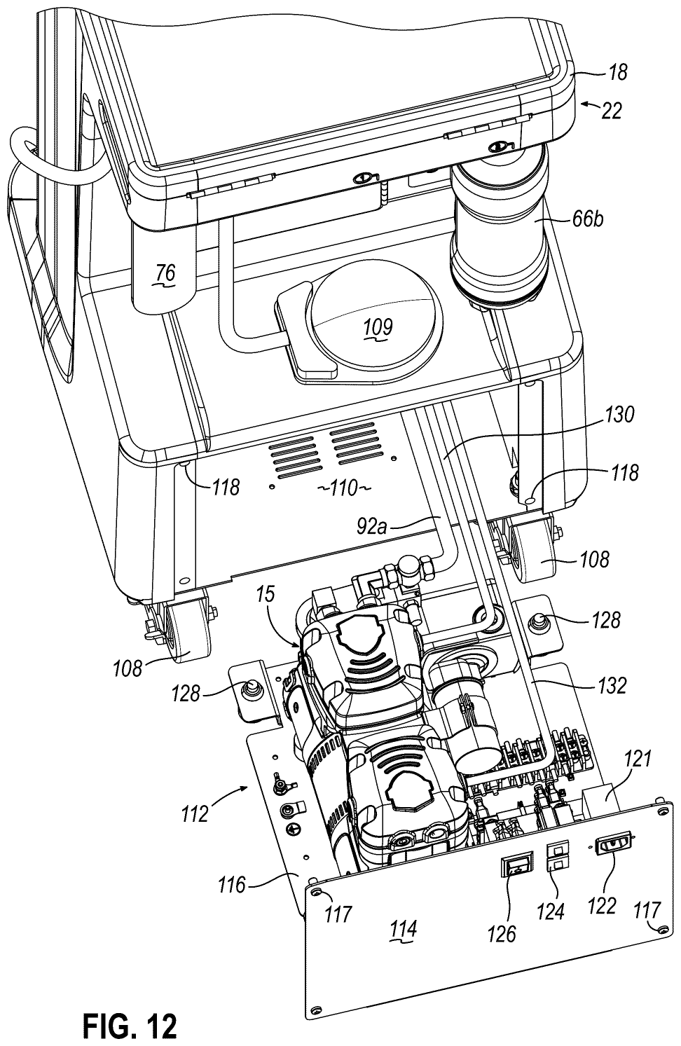

As shown in FIGS. 1-12, the present disclosure relates to a mobile dental delivery system (1). Mobile dental delivery system (1) includes a housing (2) and extends from a top (3) to a bottom (4), and for orientation purposes, includes a front area (5) and a back area (6). Conceptually, mobile dental delivery system (1) may be discussed with respect to an upper section (10), a middle section (12), and a lower section (14) and relies on a compressor (15) (FIG. 12) for pressurized air within the system.

### A. Upper Section

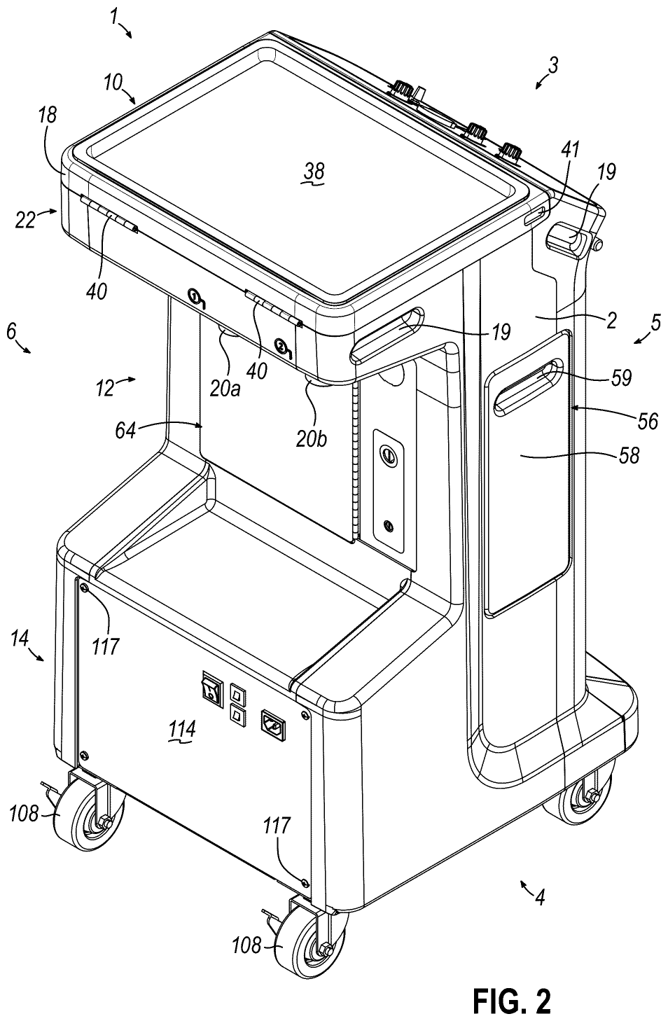

As shown in FIGS. 1 and 2, with respect to upper section (10), mobile dental delivery system (1) includes a control panel (16), a top panel (18), and various handle cutouts (19) defined by housing (2). At back area (6), mobile dental delivery system (1) includes at least one lock collar (20), shown as lock collars (20A, 20B), extending downwardly from a ledge area (22). Alternatively, lock collars (20) may be a separable element and may disengage from mobile dental delivery system (1). At front area (5), a series of hand tool holders (24) are provided for hanging or clamping the various hand tools used by a veterinarian in furtherance of animal health activities using mobile dental delivery system (1).

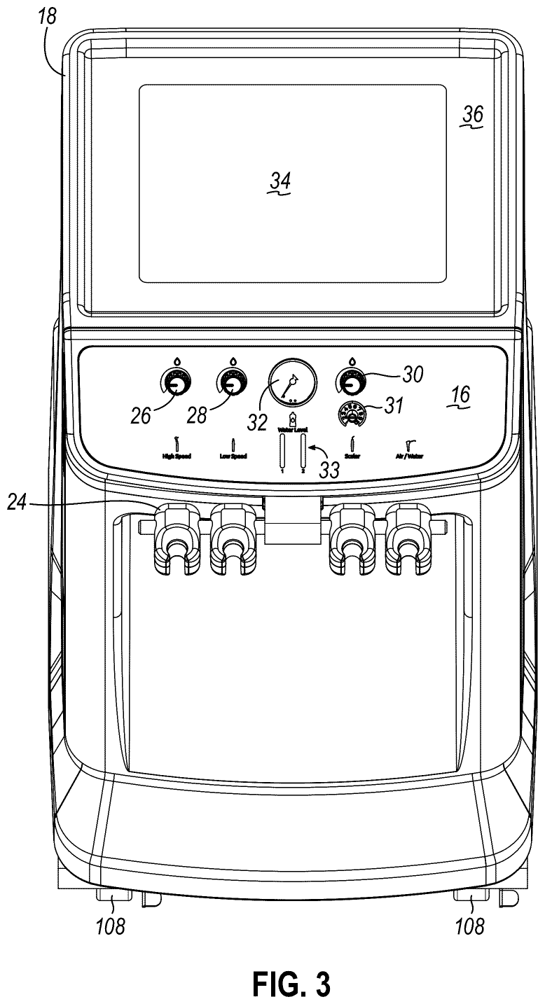

As shown in FIG. 3, control panel (16) contains various knobs and features to enable the user to manipulate the performance of the hand tools as well as observe system metrics and information. More specifically, control panel (16) includes a first knob (26), a second knob (28), and a third knob (30). Knobs (26, 28, 30) all rotate axially to engage with a manifold or block type of element inside housing (2), which will be described in greater detail below, to adjust the amount of fluid passing into the associated hand tool. In the example shown in FIG. 3, first knob (26) adjusts the water flow through a high-speed hand tool, second knob (28) adjusts the water flow through a low speed hand tool, and third knob (30) adjusts the water flow through a scaler tool for removing plaque and calculus (tartar) from animal teeth. A dial (31) is provided for adjusting the speed and/or intensity of the scaler. A pressure gauge (32) is provided on control panel (16) to provide visual feedback regarding the air pressure level provided to a hand tool when that hand tool is in use. A water level indicator (33) is provided on control panel (16) to provide visual feedback regarding the amount of water in each water container, as described in greater detail below. Water level indicator (33) may include LED lights that project different colors depending on the water level in the water bottle or provide a graphical “level” of the water bottle on water level indicator (33) by way of an increasing or decreasing panel of lights.

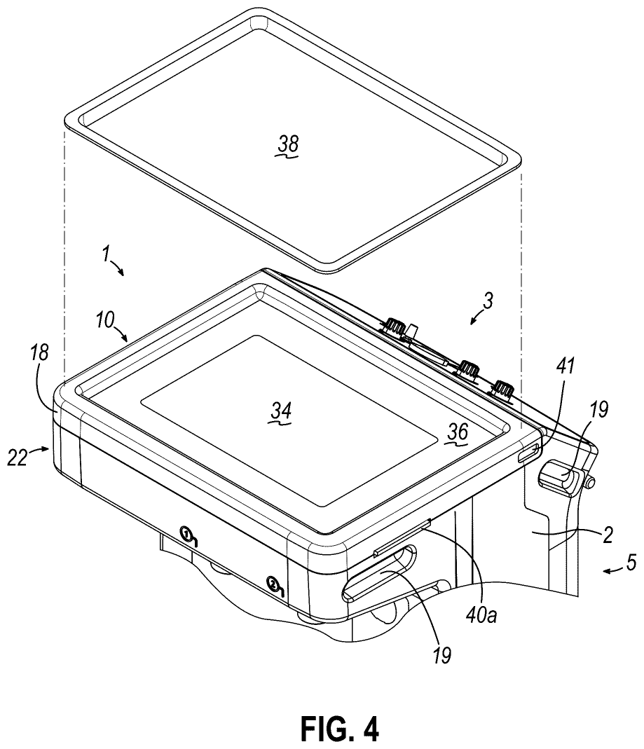

Top panel (18) includes indicia (34) such as maintenance checklists, a scaler tip wear guide, and/or a QR code for linking to additional training videos or resources. Top panel (18) defines a recessed area (36) which is a depressed tray-like area for holding tools and providing a general workspace for a healthcare professional. For example, various documents or tools or medical elements may be placed in recessed area (36) during an operation or during the movement of mobile dental delivery system (1). As shown in FIG. 4, a removable tray (38) may be provided and sized accordingly to fit snuggly and cooperatively within recessed area (36) and provide a removable and washable insert. Some versions of tray (38) may be ridged, while other versions of tray (38) like the one shown in FIG. 4 may be made from a flexible material such as an elastomer or other similar material.

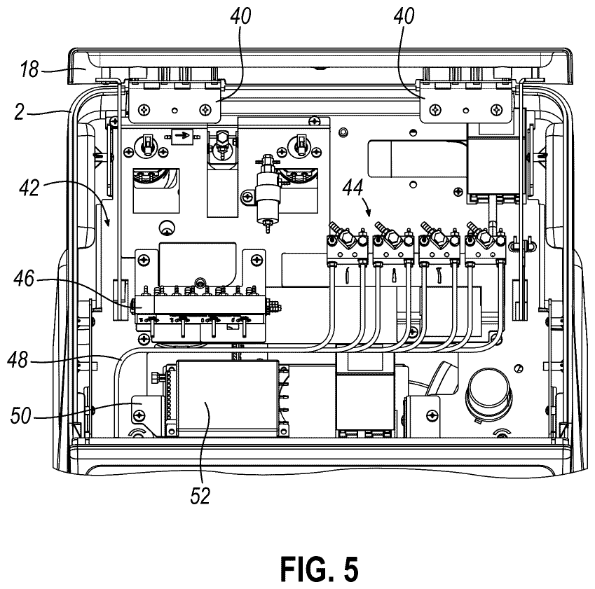

As shown in FIGS. 3-5, top panel (18) may be connected to the rest of housing (2) by way of a hinge (40) and movable between an open position (FIG. 5) and a closed position (FIG. 3). Hinge (40) may be disposed at back area (6) of mobile dental delivery system (1) to allow top panel (18) to open away from the operator positioned at front area (5), similar to a car hood type of engagement and opening. Hinge (40) may also alternatively be disposed on the rear side area of top panel (18) as shown by way of hinge (40A). A notch (41) may be defined between top panel (18) and the surrounding portion of housing (2) to allow a user to lift up top panel (18). Notch (41) provides an opening feature without the need for an element that extends outwardly away from housing (2), which would increase the profile of mobile dental delivery system (1).

The opening of top panel (18) by way of hinge (40) and notch (41) exposes an upper service chamber (42) defined by housing (2), wherein the upper service chamber (42) is accessible when top panel (18) is in the open position, and wherein upper service chamber (42) is inaccessible when top panel (18) is in the closed position. Upper service chamber (42) contains various internal components of mobile dental delivery system (1) including wiring, tubing, electronics, knob mechanics, harnesses, and other components related to administering the functionality of mobile dental delivery system (1). Upper service chamber (42) is defined behind top panel (18) for ease of access and to increase the efficiency with which components may be serviced by a technician or even the healthcare professional.

As shown in FIG. 5, upper service chamber (42) may house all or part of a valve block (44). In some versions of mobile dental delivery system (1), valve block (44) acts as a central plumbing system, directing the flow of air and water to the dental tools. Each incoming line (e.g. air from compressor (15) or water from a reservoir) connects to a dedicated port on valve block (44). Then, depending on the healthcare professional's chosen tool and procedure, valve block (44) routes the desired fluid to the handpiece or scaler. This controlled flow ensures the healthcare professional has the right pressure and volume of fluid at the hand tool for optimal treatment, while preventing unwanted cross-contamination between lines. Upper service chamber (42) may further house all or part of a pressure setting element (46). Pressure setting element (46) may be used in connection with valve block (44) to tune and control the lines and associated water and air as well as the pressure associated with each. With respect to serviceability, elements such as valve block (44) and pressure setting element (46) are disposed in upper service chamber (42) and accessible when top panel (18) is in the open position, and inaccessible when top panel (18) is in the closed position.

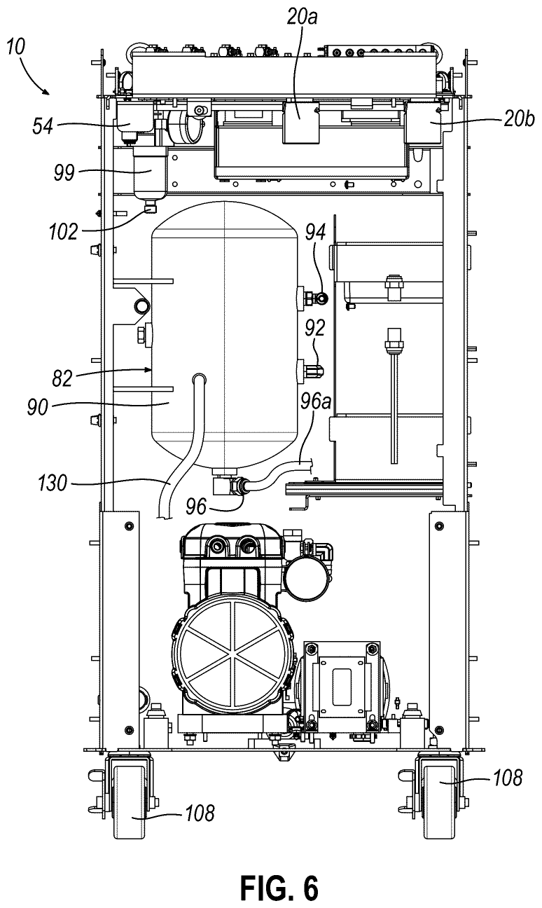

As shown in FIG. 6, upper section (10) may include a pressure regulator (54). Pressure regulator (54) receives pressurized air, either directly from air compressor (15) or indirectly from an intermediate reservoir air tank (discussed in greater detail below). The different hand tools and equipment within mobile dental delivery system (1) may require specific air pressure levels to function effectively and safely. For example, a dental drill might need higher pressure than a water sprayer tool, or a particular tool may need dynamic pressure changes during operation. Pressure regulator (54) may also safeguard against sudden pressure spikes in the system and in turn extend equipment life by providing correct and consistent pressure. Pressure regulator (54) allows adjusting the air pressure delivered to each tool through a dedicated port or a single outlet with adjustable settings. This ensures efficient operation and prevents damage to tools due to over-pressure or under-pressure conditions.

As shown in FIG. 5, upper service chamber (42) may house all or part of a series of tubing (48), a harness (50), and/or a circuit board (52). Tubing (48) may be used for air or water, harness (50) may be used to hold various elements in place inside upper service chamber (42), and circuit board (52) may be used for controlling and actuating various electronics within mobile dental delivery system (1). Similarly, system elements such as pressure regulator (54) may include serviceable parts exposed within upper service chamber (42) such as a cap (not shown) or valves that extend into upper service chamber (42) for ease of access. These elements aid in the functionality of mobile dental delivery system (1) and similarly need servicing and checking from time to time to enable efficient and continuous operation of mobile dental delivery system (1). Easy access via top panel (18) allows a technician or a healthcare professional to quickly assess and service the components of mobile dental delivery system (1) disposed therein. The lack of a latch or screws or a secured panel element aid in this efficient serviceability.

### B. Middle Section

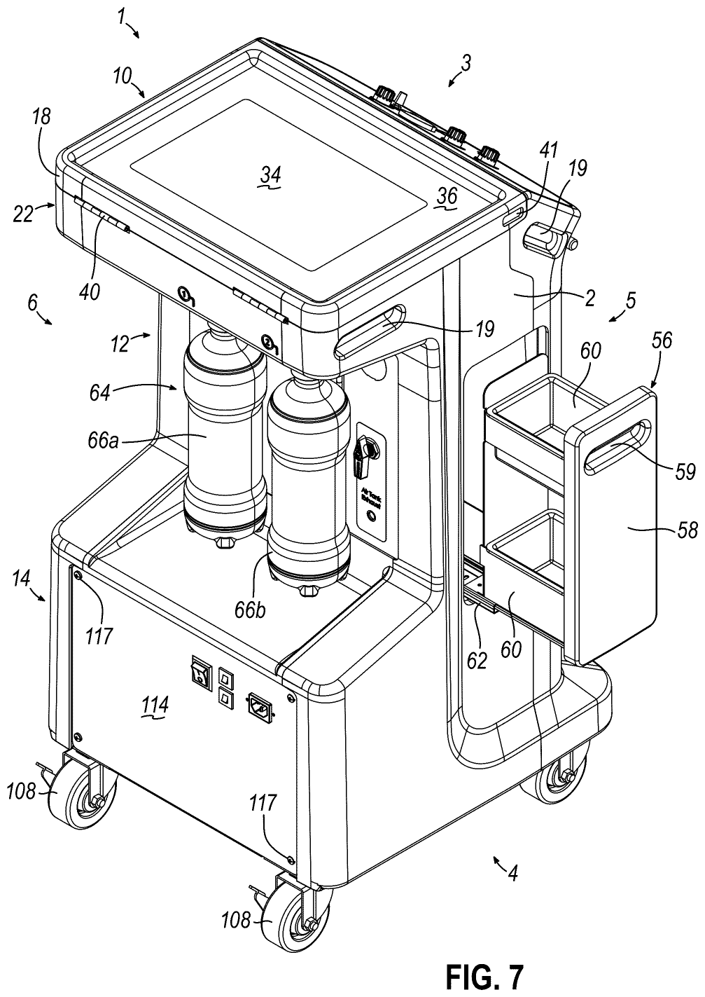

Middle section (12) includes a storage system (56) having a storage door (58), a handle (59), one or more storage bins (60), and a sliding rail system (62). Storage door (58) is a flat exterior panel or section of housing (2) that defines handle (59) indented therein. Handle (59) is defined by a recessed area or indent rather than an outwardly extending handle element to reduce the profile of mobile dental delivery system (1) and streamline this surface along the side exterior of housing (2). As shown in FIG. 7, storage door (58) may be pulled to reveal one or more storage bins (60) accessible to the user for storing veterinary materials or implements. In the illustrated example, two bins (60) are provided and are removable for cleaning or reconfiguring the storage system. For example, two shorter bins (60) may be removed and replaced with one long bin (not shown). Storage door (58) and the framework elements for holding bins (60) are connected to sliding rail system (62). As the user pulls handle (59) of storage door (58), bins (60) slide outwardly from housing (2) by way of sliding rail system (62) and are thereby accessible to a user. When not desired, the user presses on storage door (58) to retract bins (60) back into housing (2) along sliding rail system (62).

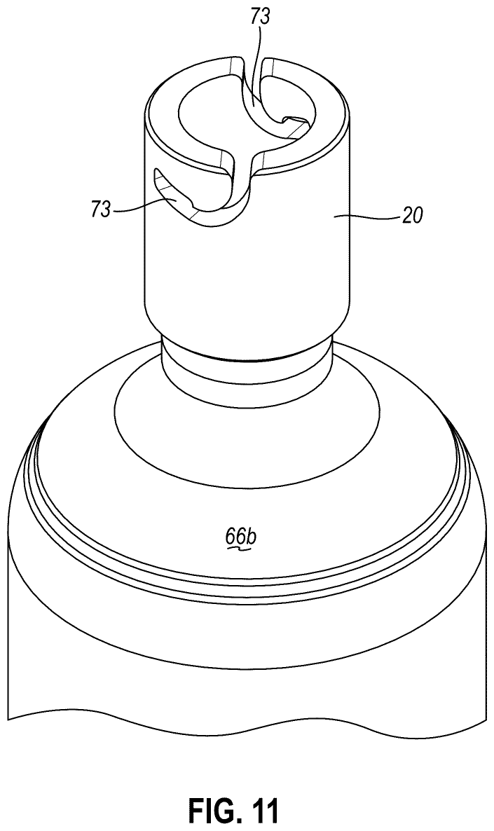

Housing (2) defines a bottle area (64), which is a recessed or cut out portion at back area (6) of mobile dental delivery system (1) under ledge area (22), primarily to create space for one or more water bottles (66) and in some versions a vacuum component (68) of a vacuum system of mobile dental delivery system (1). As described above, when coupled with mobile dental delivery system (1), lock collar (20) extends downwardly from ledge area (22) to provide a connector element for water bottle (66). However, in some versions, lock collar (20) may be separately disengaged with mobile dental delivery system (1) as shown in FIG. 11.

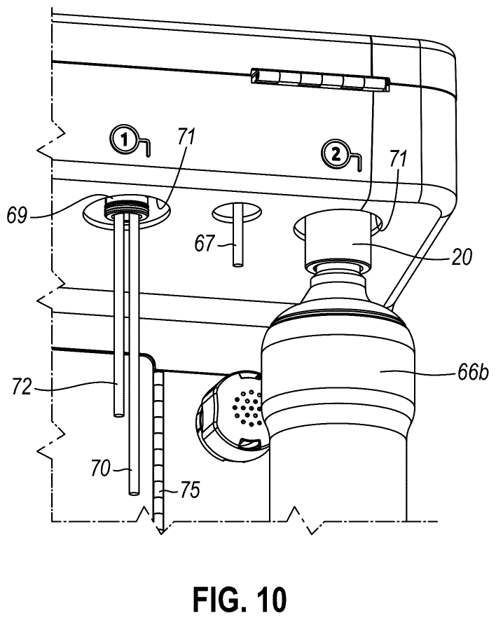

As shown in FIGS. 10 and 11, lock collar (20) is internally threaded at the top and bottom to provide a connection between the top of water bottle (66) and mobile dental delivery system (1). More specifically, mobile dental delivery system (1) includes a connector (69) extending downward from ledge area (22) through an aperture (71) defined by housing (2) to provide a mechanism for securing lock collar (20) and water bottle (66) thereto. A locking cutout (73) is defined within lock collar (20), which facilitates a press/twist type of locking engagement with connector (69) within housing (2). This locking engagement provides an air tight seal between water bottle (66) and connector (69).

A water level sensor (70) passes through connector (69) and lock collar (20) to be disposed within water bottle (66) when water bottle (66) is connected to housing (2) via lock collar (20). Water level sensor (70) includes wires (not shown) extending down the length of the sensor (70) to determine water level via capacitance measurements obtained via the wires. Water level sensor (70) is operably connected to water level indicator (33) to provide visual indication to the user of the amount of water inside water bottle (66). Similarly, a water pickup hose (72) passes through connector (69) and lock collar (20) to be disposed within water bottle (66) when water bottle (66) is connected to housing (2) via lock collar (20). An air line (not shown) to transmit air into water bottle (66) terminates within connector (69). When water bottle (66) and lock collar (20) are connected to connector (69) via an air tight seal, the air line is oriented and terminates within connector (69) to pressurize water bottle (66).

Once water pickup hose (72) is disposed within water bottle (66) and water bottle (66) is pressurized via the air line terminating in connector (69), water pickup hose (72) pulls water out from water bottle (66) via pressure and transmits it to valve block (44) to be distributed to the proper hand tool as desired by the user. A selector (67) is provided to allow a user to toggle between which water bottle (66) is pressurized. Some versions of selector (67) are three-position selectors, with a first position opening a valve channel to facilitate the pressurization of a first water bottle (66A, not shown) and closing a pressurization valve of a second water bottle (66B, FIG. 10); with a second position opening a valve channel to facilitate the pressurization of second water bottle (66B) and closing a pressurization valve of first water bottle (66A, not shown), and the center position closing a pressurization valve of both first water bottle (66A, not shown) and second water bottle (66B). Closing pressurization valves to a particular water bottle (66) allow a user to disengage water bottle (66) with connector (69) to refill it with water or provide service to water bottle (66) or other associated elements such as water level sensor (70) or water pickup hose (72).

In certain embodiments, the mobile dental delivery system (1) may include a vacuum component (68), which utilizes incoming pressurized air from compressor (15) to generate suction via a Venturi/Bernoulli configuration oriented to receive pressurized air as input, along with a small opening to allow surrounding air to be drawn into the low-pressure zone created by the accelerated air stream in the throat, and a collection chamber (not shown) for the evacuated air and any captured particulates that are entrained into the evacuated air. The vacuum created by vacuum component (68) is utilized by a vacuum hand tool provided to the healthcare professional and may be used for evacuating dental surgical sites and other situations in which suction may be required.

Middle section (12) further includes an access door (74) and a handle (76) extending outwardly away therefrom for grasping by the user to open and shut access door (74). In some versions of mobile dental delivery system (1), access door (74) is ferromagnetic and locked in a closed position by way of a magnet latch (78). Magnet latch (78) is sized and positioned to hold access door (74) closed until the magnetic attraction between access door (74) and magnet latch (78) is overcome by a user pulling on handle (76).

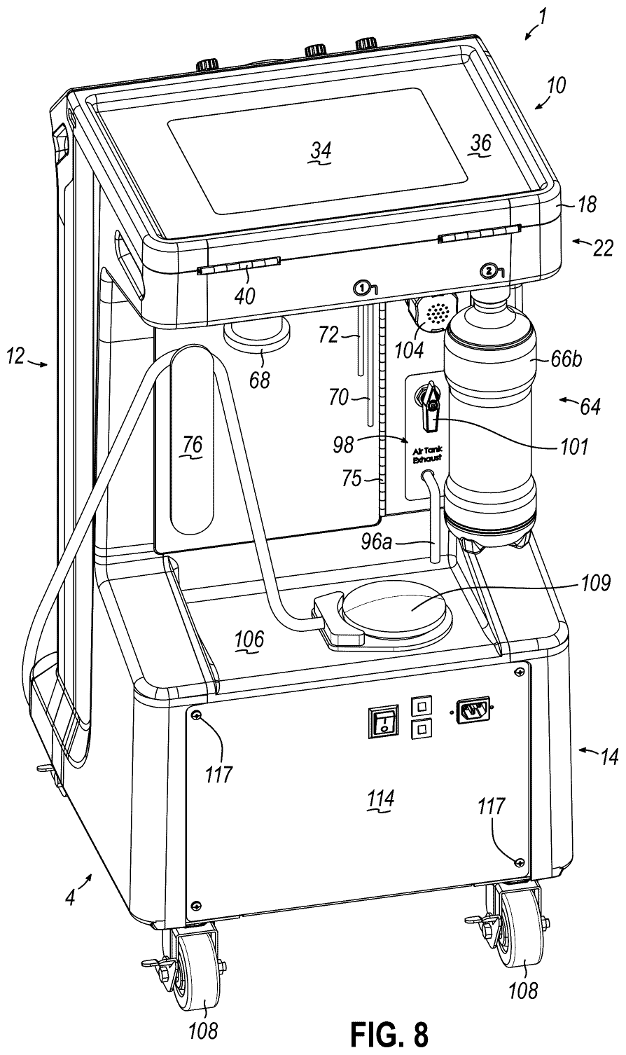

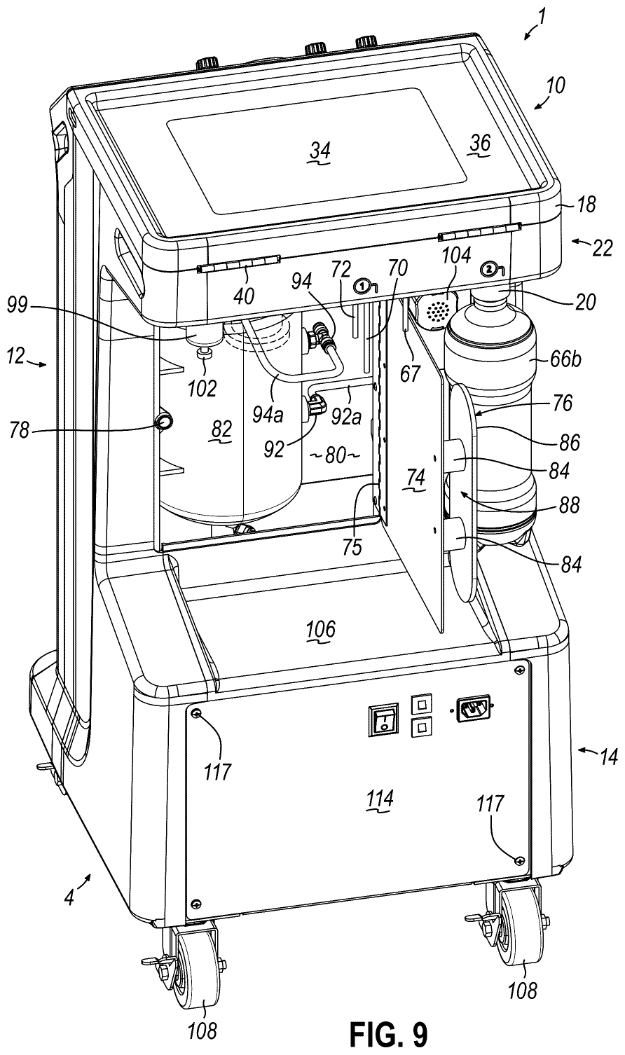

Handle (76) is further configured and shaped to provide cord storage for the power cord (not shown) and/or a foot actuator (discussed in greater detail below, shown in FIG. 8) as mobile dental delivery system (1) is moved about. As shown in FIG. 9, some versions of handle (76) include a pair of pegs (84) extending outwardly away from access door (74) to a grip element (86), which the user grasps to move access door (74). Access door (74), pegs (84), and grip element (86) cooperatively define a cord channel (88), which provides a sturdy mechanism to guide the power cord for smooth and secure wrapping. During movement, the user wraps power cord around handle (76). Once mobile dental delivery system (1) is in position, the user unwraps the power cord from handle (76) and plugs it in to re-energize mobile dental delivery system (1).

Access door (74) is connected to housing (2) by way of a hinge (75), which allows access door to swing between an open position (FIG. 9) and a closed position (FIG. 8), wherein a middle service chamber (80) defined by housing (2) is accessible when access door (74) is in the open position, wherein middle service chamber (80) is inaccessible when access door (74) is in the closed position. Middle service chamber (80) provides access to an air tank (82) and various hoses and connections associated therewith. Air tank (82) stores compressed air provided by compressor (15) and acts as an internal reservoir to build up and store this compressed air for use by the hand tools and other components of mobile dental delivery system (1). Air tank (82) eliminates the need to constantly run compressor (15) during a procedure. Instead, compressor (15) only needs to activate to refill air tank (82) when the air pressure drops below a certain level. This reduces wear and tear on compressor (15), leading to longer service life and less maintenance.

As shown in FIG. 6, air tank (82) includes a body (90), an inlet (92), an outlet (94), and a drain (96). Some versions of body (90) may be fabricated from high-strength steel or corrosion-resistant aluminum for durability and pressure containment, with appropriate wall thickness for holding pressurized air for mobile dental deliver system (1). Inlet (92) provides the connection point for intake of compressed air from compressor (15). Inlet (92) may feature a threaded or quick-connect mechanism for secure and leak-proof attachment. Some versions of inlet (92) may incorporate a one-way check valve (not shown) to prevent backflow of air to compressor (15) and/or may include a pressure relieve valve (not shown) to prevent over-pressurization and ensure safety. Outlet (94) delivers compressed air as needed to the hand tools and other components of mobile dental delivery system (1). Some versions of outlet (94) may incorporate a pressure regulator proximate outlet (94), or alternatively, as shown in FIG. 6, a separate pressure regulator (54) may be provided downstream of outlet (94) to adjust air pressure to specific tool requirements. Outlet (94) may also include a shut-off valve for controlled air flow and system isolation. Finally, drain (96) allows for the removal of condensate and moisture buildup from within air tank (82). Drain (96) is strategically located at the lowest point of air tank (82) for efficient drainage. Drain (96) may feature a manual or automatic drain valve for easy moisture removal as regular draining ensures optimal air quality and prevents corrosion within air tank (82).

Various tubing is required to connect each element described above to the associated adjacent element in mobile dental delivery system (1). More specifically, a tube (92A, FIG. 9) extends to inlet (92) from an upstream component such as air compressor (15); a tube (94A, FIG. 9) extends from outlet (94) to a downstream component such as pressure regulator (54); and a tube (96A, FIG. 6) extends from drain (96) to a downstream component, such as an external drain catch area (98), as shown in FIG. 8. Drain catch area (98) may further include a drain valve (not shown) connected to a knob (101). The drain valve may be configured to prevent the collected condensate from air tank (82) from passing therethrough until a user turns knob (101) a quarter turn (or similar) to open the drain valve. In this configuration, a user might provide a rag or small catch bucket or similar element under the end of tube (96A), and then turn knob (101) to open the drain valve, which allows the condensate to exit tube (96A).

Middle service chamber (80) may provide access to various other components within mobile dental delivery system (1). For example, as shown in FIGS. 6 and 9, pressure regulator (54) may include a condensation collection chamber (99) for collecting the water and condensation within pressure regulator (54) that builds up over time through use. A pin (102) may be provided at the bottom end of condensation collection chamber (99). Pin (102) is configured to open a channel between condensation collection chamber (99) and the exterior of pressure regulator (52) when pressed, such that a user can press a rag or similar object against pin (102) to release the collected condensation and clear out condensation collection chamber (99). With respect to serviceability, elements such as air tank (82), inlet (92), outlet (94), and drain (96) are disposed in middle service chamber (80) and accessible when access door (74) is in the open position, and inaccessible when access door (74) is in the closed position.

As shown in FIG. 8, an exhaust vent (104) may be provided within middle section (12) extending through housing. Exhaust vent (104) is operably connected to exhaust air from the hand tools. An amount of gauze or similar material (not shown) may be packed into the rearward facing side (internal side) of exhaust vent (104) to catch any moisture or oil entrained in the flow of exhaust air, which ultimately passes through housing (2) to vent to the exterior through exhaust vent (104).

As shown in FIGS. 8 and 9, a work area (106) is provided as a platform surface under the outswing rotation of access door (74) and under water bottles (66). Work area (106) provides a generally flat area for a service technician or another user to place items or rest various components such as the foot pedal shown in FIG. 8 or the screws shown in FIG. 9. Work area (106) is convenient during servicing of elements within middle service chamber (80), or any other portion of mobile dental delivery system (1).

### C. Lower Section

As shown in FIGS. 2, 6, and 12, with respect to lower section (14), mobile dental delivery system (1) includes a set of wheel assemblies (108) for aiding in physically moving mobile dental delivery system (1) around as desired. Lower section (14) further includes a foot pad (109) for placing on the ground and allowing a user to press to actuate hand tools or other features of mobile dental delivery system (1). Lower section (14) further defines a lower service chamber (110) defined by housing (2). Lower service chamber (110) includes ventilation cuts (111) defined in housing (2) to allow for venting of components disposed within lower service chamber (110) and reduce heat therein.

Lower service chamber (110) is sized to removably hold a compressor service assembly (112) therein. Compressor service assembly (112) includes a front plate (114) extending generally orthogonally from a base plate (116), which acts as a tray to allow compressor service assembly (112) to slide in and out of lower service chamber (110) for servicing. Compressor service assembly (112) is securely held within lower service chamber (110) by way of a set of screws (117) passing through front plate (114) and into similarly sized receiving apertures (118) defined by housing (2). These screws (117) are easily and quickly removable to allow compressor service assembly (112) to be removed fully or partially from lower service chamber (110). Thus, compressor service assembly (112) is movable between a secured state (FIG. 2), where front plate (114) is secured or connected to housing (2), and an unsecured state (FIG. 12), where screws (117) are removed and compressor service assembly (112) is at least partially removed from lower service chamber (110).

The terms “secured” and “unsecured” in this sense refers to whether the compressor service assembly (112) is connected to housing (2) via screws (117) or any other connection mechanism (i.e. secured) or whether screws (117) have been removed or disengaged with housing (2) (i.e. unsecured). As shown in FIGS. 2 and 12, lower service chamber (110) is defined by housing (2) and lower service chamber (110) and the compressor service assembly (112) are accessible when compressor service assembly (112) is in the unsecured state, and lower service chamber (110) is inaccessible when compressor service assembly (112) is in the secured state.

Compressor service assembly (112) includes compressor (15), shown as a two-piston compressor, as well as power couplings (120), which generally include wiring and a transformer (121) to provide power the various components of mobile dental delivery system (1). Compressor (15) is accessible when compressor service assembly (112) is in the disconnected state and inaccessible when compressor service assembly (112) is in the connected state.

Compressor service assembly (112) includes various other features such as a power cord mount (122), an ON/OFF switch (124), a pressure switch (126), and foot mounts (128). Each foot mount (128) secures a rubber foot (not shown) which helps to isolate the compressor service assembly (112) and which extends downwardly and aligns with the vertical termination point of front plate (114) to allow entire compressor service assembly (112) to sit generally horizontally on a surface and provide a sturdy platform for the service technician as parts of compressor service assembly (112) are checked and serviced.

Pressure switch (126) acts as a control element within the compressed air circuit, monitoring real-time pressure levels and triggering corresponding actions via electrical relays. When air pressure in air tank (82) falls below a predetermined threshold, pressure switch (126) activates compressor (15) to restore the pressure in air tank (82) to above the threshold. This maintains a readily available air supply, eliminating the need for constant compressor operation and reducing noise and wear. Some versions of pressure switch (126) also control the power supply to compressor (15) or other components based on air pressure levels. This optimizes energy consumption and reduces unnecessary power draw.

Compressor service assembly (112) is connected to three umbilical style cords, tubes, or lines extending into lower service chamber (110) and on to connect with various components of mobile dental delivery assembly (1). The tubing may be constructed from high-durability, pressure-resistant materials, including thermoplastic elastomers reinforced with abrasion-resistant outer layers. One or more of the lines may incorporate quick-connect fittings for tool-less connection and disconnection during servicing. To prevent entanglement or damage, one or more of the lines may be routed through flexible conduit channels integrated within housing (2). The first line extending from compressor service assembly (112) is a pressure return line (130) from air tank (82), which extends from air tank (82) to pressure switch (126). Pressure return line (130) is the feedback mechanism to provide pressure switch (126) with a constant pressure reading of air tank (82) to aid in controlling the pressure circuit. The second line extending from compressor service assembly (112) is tube (92A), which has been previously described as providing compressed air to air tank (82). The origin of this tubing element is compressor (15), which provides the compressed air to tube (92A), which thereby transports it to air tank (82). The third line extending from compressor service assembly (112) is a power harness (132) for transmitting power from power coupling (120) elements such as transformer (121) into the remainder of mobile dental delivery assembly (1) for use in the various powered features, such as control panel (16) and circuit board (52) and any powered hand tools.

To provide enough lead to allow a service technician to remove compressor service assembly (112) completely from lower service chamber (110), all three lines extending from compressor service assembly (112) are equal to, or longer than, 63 inches in length, from tip to tip. The term “completely” in this disclosure refers to the entire compressor service assembly (112) being disposed outside of housing (2), except for one or more of the tubes extending from compressor service assembly (112) and into housing (2). Rather than a common drawer-like configuration, where there exists a stopping point or some other mechanism to prevent compressor service assembly (112) from being removed entirely from housing (2), the present disclosure contemplates complete remove of compressor service assembly (112) from housing (2) and more specifically, from lower service chamber (110). This functionality allows for full access to all components disposed thereon as well as enough room to get into every area and service parts. Thus, it is one of the features of mobile dental delivery system (1) that compressor service assembly (112) is connected to an element disposed in the housing (e.g. air tank (82)) by way of a tube (e.g. tube (92A)), wherein the tube includes a length, and wherein the length is sufficient to allow complete removal of compressor service assembly (112) from lower service chamber (110), such as shown in FIG. 12. The length of the tube in the example shown in the present disclosure is at least sixty-three (“63”) inches.

One or more of the lines extending from compressor service assembly (112) may be color-coded for ease of identification and/or labeled with icons or text corresponding to its function (e.g., air, power, or feedback). The tubing lengths, at least 63 inches from tip to tip, ensure full accessibility to components during servicing without disconnection. Additionally, inline sensor(s) may be provided within pressure return line (130) to provide real-time feedback to control panel (16), enhancing monitoring and operational efficiency.

### II. Serviceability

Mobile dental delivery system (1) includes the enhanced serviceability features provided for maintaining and fixing system components, which in turn increases “uptime” and the quick turn around by a technician to get mobile dental delivery system (1) serviced and back into usage by the healthcare professional. To that end, mobile dental delivery system (1) provides upper service chamber (42), middle service chamber (80), and lower service chamber (110) for enhanced serviceability of the internal components of mobile dental delivery system (1). Upper service chamber (42) is quickly and easily accessible by way of the hinged movement of top panel (18) to expose interior components of upper service chamber (42) such as valve block (44), pressure settings element (46), tubing (48), circuit board (52), and portions of pressure regulator (54). Similarly, middle service chamber (80) is quickly and easily accessible by way of the opening of access door (74) to expose interior components of middle service chamber (80) such as air tank (82), inlet (92) and associated tube (92A), outlet (94) and associated tube (94A), and drain (96) and associated tube (96A). Finally, lower service chamber (110) is quickly and easily accessible by way of easily removable screws (117) extending through front plate (114). When removed, base plate (116) is pulled out of lower service chamber (110) to remove compressor service assembly (112) entirely from lower service chamber (110), given each of the connecting cords/lines are at least 63 inches long. This allows the technician to access a full 360-degree view of compressor (15), power couplings (120), pressure switch (126), and related elements.

In addition to serviceability of internal components, components were designed, oriented, and placed to allow enhanced maintenance by the user, which typically includes adding water to water bottle(s) (66) and removing collected fluid from air tank (82) and pressure regulator (54). Water bottle(s) (66), which need to be refilled frequently, are disposed on the exterior of mobile dental delivery system (1). This allows the user to quickly disconnect and refill water bottle(s) (66) and replace these without opening any compartments. Similarly, selector (67) extends to the exterior of housing (2) to allow a user to shut off the pressurizing functionality to the particular water bottle (66).

To further enhance serviceability and maintenance, drain tube (96A) is provided at the exterior of housing (2) with an associated knob (101), also on the exterior of housing (2), whereby a user simply turns the exhaust knob (101) to open a valve to allow fluid to flow through tube (96A) and into a catch cup or rag. Similarly, while internal to housing (2), condensation collection chamber (99) is also provided with an easily accessible pin (102) for depressing to open a valve and allow collected fluid to flow outwardly into a cup or rag to empty pressure regulator (54).

### III. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A mobile dental delivery system comprising: (a) a housing; (b) a top panel, wherein the top panel is connected to the housing via a hinge and movable between an open position and a closed position; and (c) an upper service chamber defined by the housing, wherein the upper service chamber is accessible when the top panel is in the open position, wherein the upper service chamber is inaccessible when the top panel is in the closed position.

### Example 2

The mobile dental delivery system of any of the previous or subsequent Examples, further comprising: (a) a water container; and (b) a water level indicator disposed on the housing, the water level indicator automatically operable to provide feedback pertaining to an amount of water in the water container.

### Example 3

The mobile dental delivery system of any of the previous or subsequent Examples, the top panel further comprising a recessed area sized to receive a removable tray.

### Example 4

The mobile dental delivery system of any of the previous or subsequent Examples, further comprising a valve block disposed in the upper service chamber, wherein the valve block is accessible when the top panel is in the open position, wherein the valve block is inaccessible when the top panel is in the closed position.

### Example 5

The mobile dental delivery system of any of the previous or subsequent Examples, further comprising a pressure setting element operably connected to the valve block, the pressure setting element operable to control water, air, and pressure associated with each line of a plurality of lines connected to the valve block.

### Example 6

The mobile dental delivery system of any of the previous or subsequent Examples, further comprising a pressure regulator disposed in the upper service chamber, wherein the pressure regulator is accessible when the top panel is in the open position, wherein the pressure regulator is inaccessible when the top panel is in the closed position.

### Example 7

The mobile dental delivery system of any of the previous or subsequent Examples, the upper service chamber comprising one or more serviceable parts disposed within the upper service chamber and positioned in a manner to allow for easy access when the top panel is in the open position.

### Example 8

The mobile dental delivery system of any of the previous or subsequent Examples, further comprising: (a) an access door, wherein the access door is connected to the housing via a hinge and movable between an open position and a closed position; and (b) a middle service chamber defined by the housing, wherein the middle service chamber is accessible when the access door is in the open position, wherein the middle service chamber is inaccessible when the access door is in the closed position.

### Example 9

The mobile dental delivery system of any of the previous or subsequent Examples, further comprising: (a) a compressor service assembly, wherein the compressor service assembly is connected to the housing via a screw and movable between a secured state and an unsecured state; and (b) a lower service chamber defined by the housing, wherein the lower service chamber and the compressor service assembly are accessible when the compressor service assembly is in the unsecured state, wherein the lower service chamber is inaccessible when the compressor service assembly is in the secured state.

### Example 10

A mobile dental delivery system comprising: (a) a housing; (b) an access door, wherein the access door is connected to the housing via a hinge and movable between an open position and a closed position; and (c) a middle service chamber defined by the housing, wherein the middle service chamber is accessible when the access door is in the open position, wherein the middle service chamber is inaccessible when the access door is in the closed position.

### Example 11

The mobile dental delivery system of any of the previous or subsequent Examples, further comprising an air tank disposed in the middle service chamber, wherein the air tank is accessible when the access door is in the open position, wherein the air tank is inaccessible when the access door is in the closed position.

### Example 12

The mobile dental delivery system of any of the previous or subsequent Examples, further comprising a storage system slidably connected to the middle service chamber, the storage system comprising: (a) a storage door movable between a retracted position and an extended position, the storage door flush with the housing when in the retracted position; and (b) one or more storage bins movable between an exterior position outside of the middle service chamber when the storage door is in the extended position and interior position within the middle service chamber when the storage door in the retracted position.

### Example 13

The mobile dental delivery system of any of the previous or subsequent Examples, further comprising a bottle area defined by the housing, where the bottle area comprises one or more connector elements, each for engaging with a water container.

### Example 14

The mobile dental delivery system of any of the previous or subsequent Examples, wherein each of the one or more connector elements is a lock collar comprising internal threading and a locking cutout.

### Example 15

The mobile dental delivery system of any of the previous or subsequent Examples, wherein each of the one or more connector elements comprises an airline, each airline operatively connected to a pressurization valve, wherein an engaged water container is pressurized by the air line when the pressurization valve is open.

### Example 16

The mobile dental delivery system of any of the previous or subsequent Examples, further comprising a selector movable to a plurality of selected positions, wherein each connector element from the one or more connector elements is associated with a selected position from the plurality of selected positions, the selected position opening the pressurization valve associated with the respective connector element.

### Example 17

The mobile dental delivery system of any of the previous or subsequent Examples, wherein the bottle area further comprises a vacuum component of a vacuum system of the mobile dental delivery system

### Example 18

A mobile dental delivery system comprising: (a) a housing; (b) a compressor service assembly, wherein the compressor service assembly is connected to the housing via a screw and movable between a secured state and an unsecured state; and (c) a lower service chamber defined by the housing, wherein the lower service chamber and the compressor service assembly are accessible when the compressor service assembly is in the unsecured state, wherein the lower service chamber is inaccessible when the compressor service assembly is in the secured state.

### Example 19

The mobile dental delivery system of any of the previous or subsequent Examples, wherein the compressor service assembly includes a compressor, wherein the compressor is accessible when the compressor service assembly is in the unsecured state, wherein the compressor is inaccessible when the compressor service assembly is in the secured state.

### Example 20

The mobile dental delivery system of any of the previous or subsequent Examples, wherein the compressor service assembly is connected to an element disposed in the housing by way of a tube, wherein the tube includes a length, wherein the length is sufficient to allow complete removal of compressor service assembly from lower service chamber.

### Example 21

A mobile dental delivery system comprising: (a) a housing; (b) a top panel, wherein the top panel is connected to the housing via a hinge and movable between an open position and a closed position; (c) an upper service chamber, wherein the upper service chamber is accessible when the top panel is in the open position, wherein the upper service chamber is inaccessible when the top panel is in the closed position; (d) an access door, wherein the access door is connected to the housing via a hinge and movable between an open position and a closed position; (e) a middle service chamber, wherein the middle service chamber is accessible when the access door is in the open position, wherein the middle service chamber is inaccessible when the access door is in the closed position; (f) a compressor service assembly, wherein the compressor service assembly is connected to the housing via a screw and movable between a secured state and an unsecured state; and (g) a lower service chamber defined by the housing, wherein the lower service chamber and the compressor service assembly are accessible when the compressor service assembly is in the unsecured state, wherein the lower service chamber is inaccessible when the compressor service assembly is in the secured state.

### Example 22

The mobile dental delivery system of any of the previous or subsequent Examples, wherein the compressor service assembly is completely removable from the lower service chamber when the compressor service assembly is in in the unsecured state.

### Example 23

The mobile dental delivery system of any of the previous or subsequent Examples, further comprising (a) an air tank disposed in the housing; (b) a lower service chamber defined by the housing; (c) a compressor service assembly, wherein a portion of the compressor service assembly is removably connected to the housing via a fastener, wherein the compressor service assembly is sized to be selectively disposed in the lower service chamber and selectively completely removed from the lower service chamber; and (d) a pressure return line having a first end secured to the compressor service assembly and a second end secured to the air tank.

### Example 24

The mobile dental delivery system of any of the previous Examples, wherein the pressure return line is at least sixty-three inches long.

### IV. Miscellaneous

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A mobile dental delivery system comprising:
(a) a housing;
(b) a top panel, wherein the top panel is connected to the housing via a hinge and movable between an open position and a closed position; and
(c) an upper service chamber defined by the housing, wherein the upper service chamber is accessible when the top panel is in the open position, wherein the upper service chamber is inaccessible when the top panel is in the closed position.

2. The mobile dental delivery system of claim 1, further comprising:
(a) a water container; and
(b) a water level indicator disposed on the housing, the water level indicator automatically operable to provide feedback pertaining to an amount of water in the water container.

3. The mobile dental delivery system of claim 1, the top panel further comprising a recessed area sized to receive a removable tray.

4. The mobile dental delivery system of claim 1, further comprising a valve block disposed in the upper service chamber, wherein the valve block is accessible when the top panel is in the open position, wherein the valve block is inaccessible when the top panel is in the closed position.

5. The mobile dental delivery system of claim 4, further comprising a pressure setting element operably connected to the valve block, the pressure setting element operable to control water, air, and pressure associated with each line of a plurality of lines connected to the valve block.

6. The mobile dental delivery system of claim 1, further comprising a pressure regulator disposed in the upper service chamber, wherein the pressure regulator is accessible when the top panel is in the open position, wherein the pressure regulator is inaccessible when the top panel is in the closed position.

7. The mobile dental delivery system of claim 1, the upper service chamber comprising one or more serviceable parts disposed within the upper service chamber and positioned in a manner to allow for easy access when the top panel is in the open position.

8. The mobile dental delivery system of claim 1, further comprising:
(a) an air tank disposed in the housing;
(b) a lower service chamber defined by the housing;
(c) a compressor service assembly, wherein a portion of the compressor service assembly is removably connected to the housing via a fastener, wherein the compressor service assembly is sized to be selectively disposed in the lower service chamber and selectively completely removed from the lower service chamber; and
(d) a pressure return line having a first end secured to the compressor service assembly and a second end secured to the air tank.

9. The mobile dental delivery system of claim 8, wherein the pressure return line is at least sixty-three inches long.

10. A mobile dental delivery system comprising:
(a) a housing;
(b) an access door, wherein the access door is connected to the housing via a hinge and movable between an open position and a closed position; and
(c) a middle service chamber defined by the housing, wherein the middle service chamber is accessible when the access door is in the open position, wherein the middle service chamber is inaccessible when the access door is in the closed position.

11. The mobile dental delivery system of claim 10, further comprising an air tank disposed in the middle service chamber, wherein the air tank is accessible when the access door is in the open position, wherein the air tank is inaccessible when the access door is in the closed position.

12. The mobile dental delivery system of claim 10, further comprising a storage system slidably connected to the middle service chamber, the storage system comprising:
(a) a storage door movable between a retracted position and an extended position, the storage door flush with the housing when in the retracted position; and
(b) one or more storage bins movable between an exterior position outside of the middle service chamber when the storage door is in the extended position and interior position within the middle service chamber when the storage door in the retracted position.

13. The mobile dental delivery system of claim 10, further comprising a bottle area defined by the housing, where the bottle area comprises one or more connector elements, each for engaging with a water container.

14. The mobile dental delivery system of claim 13, wherein each of the one or more connector elements is a lock collar comprising internal threading and a locking cutout.

15. The mobile dental delivery system of claim 13, wherein each of the one or more connector elements comprises an airline, each airline operatively connected to a pressurization valve, wherein an engaged water container is pressurized by the air line when the pressurization valve is open.

16. The mobile dental delivery system of claim 10, further comprising:
(a) a lower service chamber defined by the housing;
(b) a compressor service assembly, wherein a portion of the compressor service assembly is removably connected to the housing via a fastener, wherein the compressor service assembly is sized to be selectively disposed in the lower service chamber and selectively completely removed from the lower service chamber; and
(d) a pressure return line having a first end secured to the compressor service assembly and a second end secured to the air tank, wherein the pressure return line is at least sixty-three inches long.

17. The mobile dental delivery system of claim 13, wherein the bottle area further comprises a vacuum component of a vacuum system of the mobile dental delivery system.

18. A mobile dental delivery system comprising:
(a) a housing;
(b) a compressor service assembly, wherein the compressor service assembly is removably connected to the housing via a fastener and selectively movable between a secured state and an unsecured state; and
(c) a lower service chamber defined by the housing, wherein the lower service chamber and the compressor service assembly are accessible when the compressor service assembly is in the unsecured state, wherein the lower service chamber is inaccessible when the compressor service assembly is in the secured state.

19. The mobile dental delivery system of claim 18, wherein the compressor service assembly includes a compressor, wherein the compressor is accessible when the compressor service assembly is in the unsecured state, wherein the compressor is inaccessible when the compressor service assembly is in the secured state.

20. The mobile dental delivery system of claim 19, wherein the compressor service assembly is connected to an element disposed in the housing by way of a tube, wherein the tube includes a length, wherein the length is sufficient to allow complete removal of compressor service assembly from lower service chamber.
